(19) United States
(12) Patent Application Publication
(10) Pub. No.: US 2014/0019496 A1
(43) Pub. Date: Jan. 16, 2014

(54) DATA TRANSFER METHOD

(71) Applicants: CHIN-YU CHIU, NEW TAIPEI CITY (TW); YU YANG CHANG, NEW TAIPEI CITY (TW)

(72) Inventors: CHIN-YU CHIU, NEW TAIPEI CITY (TW); YU YANG CHANG, NEW TAIPEI CITY (TW)

(73) Assignees: KINPO ELECTRONICS, INC., NEW TAIPEI CITY (TW); CAL-COMP ELECTRONICS & COMMUNICATIONS COMPANY LIMITED, NEW TAIPEI CITY (TW)

(21) Appl. No.: 13/587,992

(22) Filed: Aug. 17, 2012

(30) Foreign Application Priority Data
Jul. 11, 2012 (TW) 101124996

(51) Int. Cl. G06F 17/30; G06F 15/16

(52) U.S. Cl. 707/827; 707/E17.01

(57) ABSTRACT

The present disclosure provides a data transfer method, for regulating the data transferring process between a transmitting-end electronic device and a receiving-end electronic device. The method includes: when the transmitting-end electronic device receives a data transfer instruction, the transmitting-end electronic device computes the quantity of the split-files according to the size of a file to be transferred; establishing a corresponding recording file; transferring the split split-files to the receiving-end electronic device via a primary transmission interface and recording the transmission progress in the recording file; when the transmission of the primary transmission interface has been interrupted, detecting whether or not the transmitting-end electronic device can transfer the split-files through a secondary transmission interface; if determined that the transmitting-end electronic device can use the secondary transmission interface for file transfer, continuing transferring the split-files to the receiving-end electronic device through the secondary transmission interface according to the recording file.

### CROSS-REFERENCE TO RELATED APPLICATION

This U.S. Non-provisional application claims the priority to Taiwan patent application Ser. No. 101124996, filed Jul. 11, 2012, entitled “Data Transfer Method”. The entire specification of which is hereby incorporated by reference in its entirety for all purposes.

### BACKGROUND

1. Technical Field

The present disclosure relates to a data transfer method in particular, to a data transfer method for regulating the data transferring processing between the transmitting-end electronic device and a receiving-end electronic device.

2. Description of Related Art

As technology advances, commonly seen electronic storage devices such as cellular phone, laptop, and tablet are generally equipped with at least one data transmission interface including Universal Serial Bus (USB) 2.0, USB 3.0, IEEE 1394, Serial Advanced Technology Attachment (SATA), a PS/2 interface, a COM PORT interface, Bluetooth interface, and WiFi, for performing data transmission using wired or wireless transmission so as to achieve the data sharing objective.

However, current electronic storage devices in practice do not have data transfer resume mechanism. In other words, currently data transferring process is instantly terminated as the transmission of the data transmission has been interrupted (e.g., communication has been interrupted or when switching between data transmission interfaces). Once the transmission is terminated, data transferred process cannot be automatically resumed even when either the data transmission link has been restored or the data transmission interface switching process has been completed.

For example, when sudden interruption occurs (e.g., battery dies or system froze) during data transferring process breaking the data transmission link between interfaces and terminating the data transfer process, the entire data transferring process must be restarted when the system recovers as the data transferring process cannot be resumed once the data transmission link has been lost.

For another instance, when a user wishes to switch between interfaces (e.g., switch between USB 3.0 and IEEE1394) during a data transferring process to speed up the data transferring process, the data transferring process also cannot be resumed once the data communication link has been interrupted. In other words, once the user interrupts the data transferring process regardless how fast switching from one interface to another is performed, the portion of data already transmitted is lost, and the entire data transferring process must be restarted.

It is known that data transmission in practice is time consuming, but in the current data transmission method, whenever data transfer has been interrupted the entire data transferring process must be restarted which not only waste user's time but also consume the power of electronic storage device resulting in user inconvenience when using the electronic storage device for data transfer.

### SUMMARY

Accordingly, an exemplary embodiment of the present disclosure provides a data transfer method for regulating data transfer between a transmitting-end electronic device and a receiving-end electronic device. The method may actively detect other alternative data transmission interfaces between the transmitting-end electronic device and the receiving-end electronic device and select a data transmission interface as replacement to continue the data transfer process in case of transmission interruption of the data transmission interface which is instantly used for data transfer between the transmitting-end electronic device and the receiving-end electronic device. The data transmission time can be effectively reduced.

An exemplary embodiment of the present disclosure provides a data transfer method which is adapted for a transmitting-end electronic device and a receiving-end electronic device. The data transfer method is used for regulating the data transferring process between the transmitting-end electronic device and the receiving-end electronic device. The method includes the following steps. Firstly, the following steps are sequentially processed on the transmitting-end electronic device. The quantity of the split-files according to the size of a file to be transferred stored in the transmitting-end electronic device are computed when the transmitting-end electronic device receives a data transfer instruction. A recording file is established in the transmitting-end electronic device in corresponding to the file to be transferred. The transmitting-end electronic device splits the file to be transferred to generate a plurality of split-files. The transmitting-end electronic device sequentially transfers the split-files to the receiving-end electronic device through a primary data transmission interface and recording the corresponding transmission progress in the recording file. When the transmission of the primary data transmission interface has been interrupted during the process of transferring the split-files, the transmitting-end electronic device detects whether or not the transmitting-end electronic device can transfer data through a secondary data transmission interface. When determined that the transmitting-end electronic device can transfer data through the secondary data transmission interface, continuing transfers the split-files to the receiving-end electronic device through the secondary data transmission interface according to the recording file. Secondly, the following steps are processed on the receiving-end electronic device. The receiving-end electronic device receives a plurality of the split-files from the transmitting-end electronic device through a primary data transmission interface. The receiving-end electronic device determines whether or not the process of transferring the split-files has been completed. The receiving-end electronic device combines the split-files to generate a receive file when the process of transferring the split-files has been completed. On the other hand, if the process of transferring the split-files has not been completed, the receiving-end electronic device sends a transmission progress message to the transmitting-end electronic device to update a recording file based on the transmission progress message.

An exemplary embodiment of the present disclosure provides a data transfer method which is adapted for a transmitting-end electronic device. The data transfer method can be used for regulating the data transferring process between the transmitting-end electronic device and a receiving-end electronic device. The method includes the following steps. The transmitting-end electronic device computes the quantity of the split-files according to the size of a file to be transferred stored in the transmitting-end electronic device, when the transmitting-end electronic device receives a data transfer instruction. The transmitting-end electronic device establishes a recording file in the transmitting-end electronic device in corresponding to the file to be transferred. The transmitting-end electronic device splits the file to be transferred to generate a plurality of split-files. The transmitting-end electronic device sequentially transfers the split-files to the receiving-end electronic device through a primary data transmission interface and recording the corresponding transmission progress in the recording file. When the transmission of the primary data transmission interface has been interrupted during the process of transferring the split-files, the transmitting-end electronic device detects whether or not the transmitting-end electronic device can transfer data through a secondary data transmission interface. When determined that the transmitting-end electronic device can transfer data through the secondary data transmission interface, continue transferring the split-files to the receiving-end electronic device through the secondary data transmission interface according to the recording file.

According to one exemplary embodiment of the present disclosure, the data transfer method further includes updating the recording file after each split-file has been transferred to correspondingly record the transmission progress associated with the split-files.

According to one exemplary embodiment of the present disclosure, the data transfer method further includes establishing a temporary folder in the transmitting-end electronic device for storing the split-files and the recording file and deleting the temporary folder after the transmitting-end electronic device completes the process of transferring split-file.

According to one exemplary embodiment of the present disclosure, the step of sequentially transferring the split-files to the receiving-end electronic device through the primary data transmission interface further includes activating a transmission interface monitor program to monitor whether or not the transmission of the primary data transmission interface has been interrupted.

According to one exemplary embodiment of the present disclosure, the step of detecting whether or not the transmitting-end electronic device can transfer data through the secondary data transmission interface further includes detecting all the data transmission interfaces between the transmitting-end electronic device and the receiving-end electronic device and selecting one of the data transmission interfaces to be the secondary data transmission interface, accordingly.

According to one exemplary embodiment of the present disclosure, the step of continuing transferring the split-files to the receiving-end electronic device through the secondary data transmission interface includes switching from the primary data transmission interface to the secondary data transmission interface to continue transferring the split-files to the receiving-end electronic device through the secondary data transmission interface.

According to one exemplary embodiment of the present disclosure, the data transfer method further includes when determined that the transmitting-end electronic device is unable to transfer data through any data transmission interface, await for the communication link with the primary data transmission interface or the secondary data transmission interface has been reestablished and continue transferring the split-files through the respective linked data transmission interface.

According to one exemplary embodiment of the present disclosure, the step of sequentially transferring the split-files to the receiving-end electronic device through the primary data transmission interface further includes continuing splitting the file to be transferred during the process of transferring the split-files until finishing splitting the file to be transferred.

According to one exemplary embodiment of the present disclosure, the step of sequentially transferring the split-files to the receiving-end electronic device through the primary data transmission interface further includes continuing splitting the file to be transferred even when the transmission of the primary data transmission interface has been interrupted until finishing splitting the file to be transferred.

An exemplary embodiment of the present disclosure provides a data transfer method which is adapted for a receiving-end electronic device. The data transfer method is used for regulating the data transferring processing between the receiving-end electronic device and a transmitting-end electronic device. The method includes the following. The receiving-end electronic device receives a plurality of the split-files from the transmitting-end electronic device through a primary data transmission interface wherein the split-files correspond to a file to be transferred. Subsequently, the receiving-end electronic device determines whether or not the process of transferring the split-files has been completed. The receiving-end electronic device combines the split-files to generate a receive file when the process of transferring the split-files has been completed. If receiving-end electronic device determines that the process of transferring the split-files has not been completed, the receiving-end electronic device sends a transmission progress message to the transmitting-end electronic device to update a recording file based on the transmission progress message.

According to one exemplary embodiment of the present disclosure, the data transfer method includes establishing a temporary folder for storing the received split-files, wherein the receiving-end electronic device retains the temporary folder prior to the completion of the split-files and deletes the temporary folder after all the split-files been received and combined into the receive file.

According to one exemplary embodiment of the present disclosure, the primary and the secondary data transmission interface respectively comprises of a Universal Serial Bus (USB), a IEEE 1394, an external Serial Advanced Technology Attachment (eSATA), a Thunderbolt interface, a PS/2 interface, a COM PORT interface, a Bluetooth interface, a WiFi, or a Registered Jack 45 (RJ45) interface.

According to one exemplary embodiment of the present disclosure, the transmitting-end electronic device is a cellular phone, a laptop, a computer, or a tablet.

According to one exemplary embodiment of the present disclosure, the receiving-end electronic device is a cellular phone, a laptop, a computer, a tablet, a flash drive, or a portable hard drive.

To sum up, an exemplary embodiment of the present disclosure provides a data transfer method for regulating data transfer between a transmitting-end electronic device and a receiving-end electronic device. The data transfer method may actively detect and select a data transmission interface as replacement to continue transfer data when data transferring process of the instantly used data transmission interface between the transmitting-end electronic device and the receiving-end electronic device has been interrupted. Accordingly, the data transmission time between the transmitting-end electronic device and the receiving-end electronic device can be effectively reduced.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a structural diagram of a data transmission system provided in accordance to the first exemplary embodiment of the present disclosure.

FIG. 2 is a structural diagram of the data transmission system provided in accordance to the first exemplary embodiment of the present disclosure.

FIG. 3-1 and FIG. 3-2 are flowchart diagrams illustrating a data transfer method adapted for a transmitting-end electronic device provided in accordance to the second exemplary embodiment of the present disclosure.

FIG. 4 is a flowchart diagram of a data transfer method adapted for a receiving-end electronic device provided in accordance to the second exemplary embodiment of the present disclosure.

FIG. 5 is a flowchart diagram of a data transfer method for data transfer interruption provided in accordance to the second exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### First Exemplary Embodiment

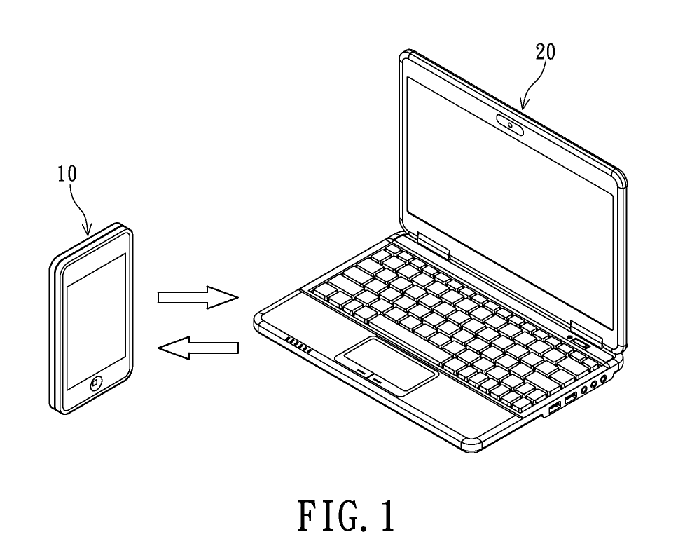

Please refer to FIG. 1, which a structural diagram illustrating a data transmission system provided in accordance to the first exemplary embodiment of the present disclosure. The data transmission system includes a transmitting-end electronic device 10 and a receiving-end electronic device 20. The transmitting-end electronic device 10 and the receiving-end electronic device 20 may perform data transferring process through a data transmission interface. The transmitting-end electronic device 10 may transfer a data or a file to the receiving-end electronic device 20 through a data transmission interface between the transmitting-end electronic device 10 and the receiving-end electronic device 20 to store the data or file in the receiving-end electronic device 20.

In particular, the transmitting-end electronic device 10 may automatically select an appropriate data transmission interface to perform data transmission between the transmitting-end electronic device 10 and the receiving-end electronic device 20 based on the communication status of the data transmission interface. To put it concretely, the transmitting-end electronic device 10 can actively detect and select an alternative data transmission interface between the transmitting-end electronic device 10 and the receiving-end electronic device 20 as replacement when the transmission of the instantly active data transmission interface has been interrupted to automatically resume the data transferring process. So that data retransmission may be eliminated when interruption occurs thereby reduce time required for the data transmission.

The transmitting-end electronic device 10 may be an electronic device having data transmission capability such as a cellular phone, a laptop, a computer, or, a tablet. The receiving-end electronic device 20 may be an electronic device having storage capability such as a cellular phone, a laptop, a computer, a tablet, a flash drive, or a portable hard drive. The transmitting-end electronic device 10 in the instant embodiment as shown in FIG. 1 may a cellular phone while the receiving-end electronic device 20 may a laptop, however the instant embodiment is not limited thereto. Taking FIG. 1 as an example, the cellular phone may transfer a file e.g. image file stored therein to the laptop through a selected data transmission interface.

The transmitting-end electronic device 10 can select a file to be transferred in corresponding to a data transfer instruction. The transmitting-end electronic device 10 further determines the size of each split-file according to the size of the file to be transferred. The transmitting-end electronic device 10 at the same time computes the corresponding quantity of the split-files according to the size of the file to be transferred. The transmitting-end electronic device 10 further utilizes file splitting method and splits the file to be transferred to generate multiple split-files having identical or different file sizes according to the computed split-file size and quantity. The data transfer instruction can be generated by the user of the transmitting-end electronic device 10. For instance, the user may create the data transfer instruction through the input interface e.g., keypad or touch screen (not shown) of the transmitting-end electronic device 10. The data transfer instruction may comprise of at least one of the associated file location of the file to be transferred and the predefined data transmission interface. The transmitting-end electronic device 10 can sequentially transfer the split split-files and store in the receiving-end electronic device through a predefined primary data transmission interface. Meanwhile during the process of transferring the split-files, the transmitting-end electronic device 10 continue performing the file-splitting process of the file to be transferred until finishing splitting the file to be transferred thereby may perform instant file transfer operation. The file to be transferred may be an image file, a text file, a video file, an audio file or a combination thereof, the instant embodiment is not limited to the example provided herein.

The file splitting method may be implemented using the file splitting technique or file compression technique, those skilled in the art should be able to infer the implementations for file splitting technique and file compression technique, thus further descriptions are therefore omitted.

When the transmission of the primary data transmission interface has been interrupted (e.g., when either the transmitting-end electronic device 10 or the receiving-end electronic device 20 has insufficient power or when system froze or when the user wish to switch between data transmission interfaces) during the process of transferring the split-file, the transmitting-end electronic device 10 may automatically detect and determine whether or not the split-files can be continue transferred to the receiving-end electronic device 20 through a secondary data transmission interface. When the transmission of the primary data transmission interface has been interrupted, if the file split process for the file to be transferred has not be completed, the transmitting-end electronic device 10 continues to split the file to be transferred till finishing splitting the file to be transferred. The transmitting-end electronic device 10 automatically switch to the secondary data transmission interface when determined that the data can be transferred through the secondary data transmission interface so as to sequentially transfer the remaining split-files to the receiving-end electronic device 20. On the other hand, if the transmitting-end electronic device 10 determines cannot transfer the data through any of the existing data transmission interfaces, the transmitting-end electronic device 10 wait until the link with the primary or secondary data transmission interface has been restored. Specifically, the transmitting-end electronic device 10 can automatically transfer the remaining split-files to the receiving-end electronic device 20 through the corresponding linked data transmission interface when either the link with the primary data transmission interface or the secondary data transmission interface has been restored. The receiving-end electronic device 20 can automatically combine the received split-file after finished receiving all the split-files to generate a receive file for the user of the receiving-end electronic device 20 to view.

Additionally, when the transmitting-end electronic device 10 detects that the data transfer rate provided by the primary data transmission interface is larger than the data transfer rate provided by the secondary data transmission interface, the transmitting-end electronic device 10 can switch back to the primary data transmission interface and continue with data transmission i.e. sequentially transferring the remaining split-files through the primary data transmission interface.

It is worth to noted that the primary data transmission interface and the secondary data transmission interface may each comprises of wired transmission interface e.g., a Universal Serial Bus (USB), a IEEE 1394, an external Serial Advanced Technology Attachment (eSATA), a Thunderbolt interface, a PS/2 interface, or a COM PORT interface or a Registered Jack 45 (RJ45) interface or wireless transmission interface e.g., a Bluetooth interface, or a WiFi. In one implementation, the data transmission interfaces (e.g., the primary data transmission interface and the secondary data transmission interface) between the transmitting-end electronic device 10 and the receiving-end electronic device 20 do not include a local area network or an internet. In another implementation, the data transmission interfaces (e.g., the primary data transmission interface and the secondary data transmission interface) between the transmitting-end electronic device 10 and the receiving-end electronic device 20 further include a local area network or an internet. In other words, the type, actual structure, and/or implementation method associated with the primary data transmission interface and the secondary data transmission interface are configured according to the type and actual structural of the transmitting-end electronic device 10 and the receiving-end electronic device 20, thus the present disclosure is not limited thereto.

Referring to the following data transmission operation examples which are utilized to illustrate the data transfer method between the transmitting-end electronic device 10 and the receiving-end electronic device 20.

Suppose the user of the transmitting-end electronic device 10 (e.g., cellular phone) wishes to transfer and store an image file (i.e., a file to be transferred) in the receiving-end electronic device 20 (e.g., laptop) through USB such as USB2.0 or USB 3.0 (i.e., the primary data transmission interface). The transmitting-end electronic device 10 and the receiving-end electronic device 20 may establish a communication link through the USB (i.e., the primary data transmission interface). The transmitting-end electronic device 10 can then determines the size of the split-files based on the size of the image file (i.e., the file to be transferred) and computes the quantity of the split-files accordingly. The transmitting-end electronic device 10 further establishes a recording file, wherein the recording file is used for recording the order and transmission progress associated with the split-files in corresponding to the image file. The transmitting-end electronic device 10 splits the image file to generate multiple split-files having identical or different file size according to the computed split-file size and the associated quantity. Subsequently, the transmitting-end electronic device 10 sequentially transfers the split-files to the receiving-end electronic device 20 through the USB (i.e., the primary data transmission interface) according to the recording file. In addition, during the process of transferring the split-files, the transmitting-end electronic device 10 continues the file-splitting process until finishing splitting the image file (i.e., the file to be transferred) and generating all the corresponding split-files. The receiving-end electronic device 20 stores the received split-files in the receiving-end electronic device 20.

During the process of transferring the split-files, whenever the transmitting-end electronic device 10 breaks down or when the data transfer rate of the USB interface (i.e., the primary data transmission interface) is lower than a predetermined value, the transmitting-end electronic device 10 terminates the data transferring process of the USB (i.e., the primary data transmission interface) and actively detects an alternative data transmission interface such as the Bluetooth interface as the secondary data transmission interface. The transmitting-end electronic device 10 then switches from the USB to the Bluetooth interface to continue transferring the remaining split-files to the receiving-end electronic device 20. Moreover, during the detection for alternative data transmission interface and data transmission interface switching process, the transmitting-end electronic device 10 continues with the file-splitting process of the image file (i.e., the file to be transferred) until finishing splitting the image file (i.e., the file to be transferred) into split-files.

When the transmitting-end electronic device 10 detects that the communication link with the USB (i.e., the primary data transmission interface) has been reestablished and the data transfer rate of the UBS is larger than the data transfer rate of the Bluetooth interface (i.e., the secondary data transmission interface), the transmitting-end electronic device 10 can switch back to the USB i.e., the primary data transmission interface) and continue transferring the remaining split-files to the receiving-end electronic device 20 through the USB (i.e., the primary data transmission interface).

When the receiving-end electronic device 20 finishes receiving all the split-files in corresponding to the file to be transfer (i.e., the image file), the receiving-end electronic device 20 combines all the split-files to generate a receive file, wherein the receive file is the same as the file to be transferred (i.e., the image file).

For another example, suppose the user of the transmitting-end electronic device 10 (e.g., cellular phone) initially uses the Bluetooth interface (i.e., the primary data transmission interface) for transferring the split-files in corresponding to an image file (i.e., the file to be transferred) to the receiving-end electronic device 20 (e.g., laptop). During the data transmission, the user found that the data transfer rate of the Bluetooth interface (i.e., the primary data transmission interface) is too slow and becomes time consuming therefore wishing to switch to a USB such as using USB 2.0 or USB 3.0 for data transfer, the user can first terminates the data transferring process of the Bluetooth interface and manually establishing the USB link between the transmitting-end electronic device 10 and the receiving-end electronic device 20. For instance, the user may through physically connecting the USB ports between the transmitting-end electronic device 10 and the receiving-end electronic device 20 to establish the USB link between the transmitting-end electronic device 10 and the receiving-end electronic device 20. Accordingly, the transmitting-end electronic device 10 may actively detects and select the presence USB as the secondary data transmission interface when the transmission via Bluetooth interface has been interrupted and continue transferring the reaming split-files of the image file to the receiving-end electronic device 20 through the USB.

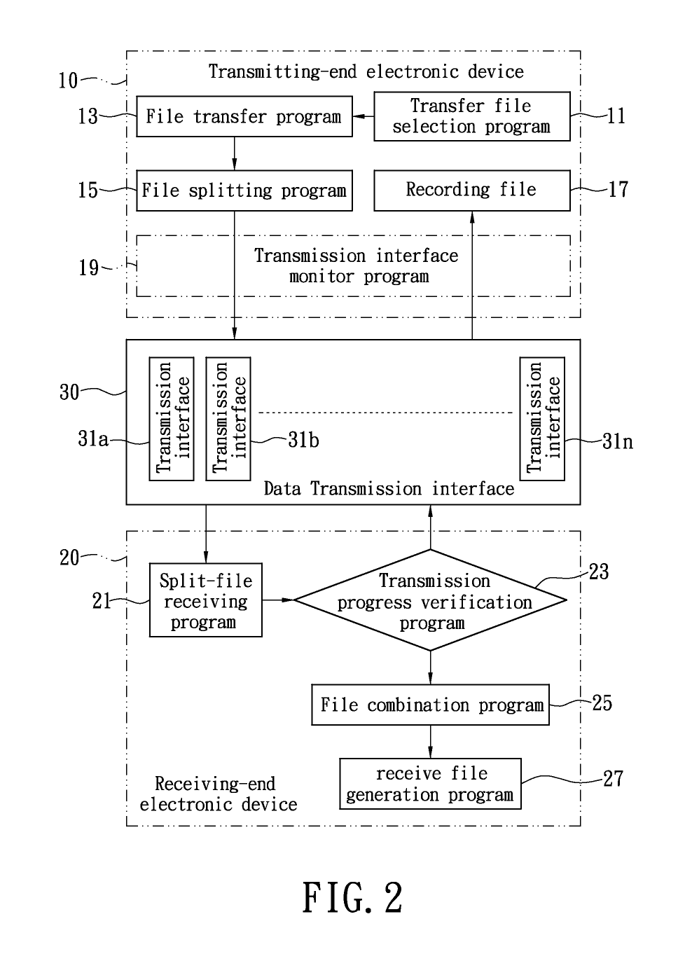

More specifically, please refer to FIG. 2, which is a structural diagram of the data transmission system provided in accordance to the first exemplary embodiment of the present disclosure. The transmitting-end electronic device 10 may for example be a cellular phone having a first processing unit (not shown). The receiving-end electronic device 20 may for example be a laptop having a second processing unit (not shown). The first processing unit and the second processing unit may be implemented by processing chips including but not limited to central processing unit, microcontroller and/or embedded controller which are respectively placed in the transmitting-end electronic device 10 and the receiving-end electronic device 20, however the instant embodiment is not limited thereto.

The first processing unit of the transmitting-end electronic device 10 executes transfer file selection program 11 to select a file to be transfer upon receiving a user-configured data transfer instruction. The first processing unit of the transmitting-end electronic device 10 then activates the file transfer program 13 and the file splitting program 15. The file splitting program 15 may first determines the size of each split-file and the quantity of the split-files according to the size of the file to be transferred. Subsequently, the file splitting program 15 can utilize the file splitting or data compression technique splitting the file to be transferred to generate multiple split-files having identical or different file size. The first processing unit of the transmitting-end electronic device 10 at same time establishes a temporary folder in the first memory unit (not shown) of the transmitting-end electronic device 10 for storing a recording file 17 and the split-files. The recording file 17 may be used to record the sequence of the split-files and the corresponding transmission progress. The first memory unit in the instant embodiment may be implemented by a volatile memory chip or a non-volatile memory chip such as a flash memory chip, a read-only memory chip or a random access memory chip, however the instant embodiment is not limited thereto.

The first processing unit may select a transmission interface (e.g., transmission interface 31a) from the data transmission interface 30 (i.e., transmission interface 31a˜31n) as the primary data transmission interface. The primary data transmission interface may be selected by the user of the transmitting-end electronic device 10. The primary data transmission interface may also be automatically detected by file transfer program 13 executed by the first processing unit, e.g., selected a transmission interface providing fastest data transfer rate, however the present disclosure is not limited to the example provide herein. The file transfer program 13 may transfer the split-files using the data transfer format corresponds to transmission protocol standard of the primary data transmission interface (e.g., transmission interface 31a) The transmitting-end electronic device 10 then transfers the split-files to the receiving-end electronic device 20 according to the recorded sequence in the recording file 17. The file splitting program 13 continues splitting the file to be transferred during the process of transferring the split-files until finished splitting the file to be transferred into split-files.

In addition, the first processing unit of the transmitting-end electronic device 10 actives a transmission interface monitor program 19 during the process of transferring the split-files for constantly monitoring whether or not the transmission of a primary data transmission interface (i.e., transmission interface 31a) has been interrupted. When the transmission interface monitor program 19 detects that the transmission of the primary data transmission interface (e.g., transmission interface 31a) has been interrupted (e.g., the transmitting-end electronic device 10 has not received the verification message in corresponding to the process of transferring the split-files or the transmission progress message from the receiving-end electronic device 20, or when the data transfer rate of the primary data transmission interface (e.g., transmission interface 31a) is lower than a predetermined value), the transmission interface monitor program 19 considers that the transmission of the primary data transmission interface (e.g., transmission interface 31a) has been interrupted. Subsequently, the first process unit drives the transmission interface monitor program 19 detecting all other existing transmission interfaces (i.e., transmission interfaces 31b-31n) between the transmitting-end electronic device 10 and the receiving-end electronic device 20 and selecting one transmission interface therein accordingly to be the secondary data transmission interface so as to resume the split-files transferring process. The secondary data transmission interface may be the data transmission interface providing fastest data transfer rate out of all the transmission interfaces 31b˜31n. The file splitting program 15 may continue with the file-splitting process of the file to be transferred when the transmission of the primary data transmission interface (e.g., transmission interface 31a) has been interrupted.

More specifically, when the transmission interface monitor program 19 determines that the transmission of the primary data transmission interface (e.g., transmission interface 31a) has been interrupted, the second processing unit of the receiving-end electronic device 20 may provide a plurality of available data transmission interfaces to the transmitting-end electronic device 10 to select from. So that the transmitting-end electronic device 10 may continue transferring the remaining split-files to the receiving-end electronic device 20 through the selected secondary data transmission interface (e.g., transmission interface 31b). Those skill in the art should know that split-files at this instant are being transferred using the data transfer format corresponds to transmission protocol standard of the secondary data transmission interface (e.g., transmission interface 31b). The transmitting-end electronic device 10 may send a request (e.g., sending a data transmission interface activation acknowledge signal) to the receiving-end electronic device 20 after selecting the secondary data transmission interface (e.g., transmission interface 31b) to activate and establish the communication link between the transmitting-end electronic device 10 and the receiving-end electronic device 20. The transmitting-end electronic device 10 may instantly transfer the remaining split-files to the receiving-end electronic device 20 through the secondary data transmission interface (e.g., transmission interface 31b) according to the recording file 17.

The second processing unit of the receiving-end electronic device 20 can receive the split-files through either the primary data transmission interface or the secondary data transmission interface. Upon receiving the split-file, the second processing unit of the receiving-end electronic device 20 instantly activates a split-file receiving program 21 which establishes a temporary folder in the second memory unit (not shown) of the receiving-end electronic device 20 storing the received split-files. The temporary folder may be retained until finish receiving the split-files. Whenever the receiving-end electronic device 20 receives a split-file, the second processing unit of the receiving-end electronic device 20 stores the split-file in the temporary folder located in the second memory unit. The second processing unit of the receiving-end electronic device 20 further drives the transmission progress verification program 23 to determine whether or not all the split-files has been transferred upon each time the receiving-end electronic device 20 receives a split-file. When the transmission progress verification program 23 determines that the process of transferring the split-files has not been completed, the second processing unit sends a transmission progress message to the transmitting-end electronic device 10 through the instantly used data transmission interface (i.e., the primary data transmission interface or the secondary data transmission interface) to have the transmitting-end electronic device 10 updating the recording file 17 according to the transmission progress message so as to correspondingly record the transmission progress of the split-files.

Incidentally, the second memory unit in the instant embodiment may have the same structure as the first memory unit. In other words, the second memory unit may be implemented by a volatile memory chip or a non-volatile memory chip such as a flash memory chip, a read-only memory chip or a random access memory chip, however the instant embodiment is not limited thereto.

When the transmission progress verification program 23 determines that the process of transferring the split-files has been completed, the second processing unit executes a file combination program 25 and a receive file generation program 27. The file combination program 25 combines or integrates the received split-files stored in the temporary folder using file recombination technique while the receive file generation program 27 correspondingly generates a receive file. The receive file is the same as the file to be transferred.

Additionally, at completion of the split-files, the second processing unit sends a transmission completion message to the transmitting-end electronic device 10 through the instantly used data transmission interface (i.e., the primary data transmission interface or the secondary data transmission interface) to have the transmitting-end electronic device 10 verifying that the process of transferring the split-files has been completed. In the same manner, the transmitting-end electronic device 10 may also sends a verification request to receiving-end electronic device 20 when transferring the last split-file to have the receiving-end electronic device 20 respond to whether or not the receiving-end electronic device 20 has finished receiving all the split-files so as to verify whether or not the process of transferring the split-files has been completed.

Moreover, if the primary data transmission interface has been interrupted prior to the completion of the split-files, the receiving-end electronic device 20 may retain the temporary folder string the split-files and wait until the transmitting-end electronic device resuming the process of transferring the split-files.

The receiving-end electronic device 20 may further delete the temporary folder located into the second memory unit after the split-files have been combined into the receive file to save the storage space of the second memory unit. Similarly, the first processing unit of the transmitting-end electronic device 10 may delete the split-files and the recording file 17 stored in the first memory unit of the transmitting-end electronic device 10 upon receiving the transmission completion message. In other words, the first processing unit of the transmitting-end electronic device 10 may delete the temporary folder stored in the first memory unit to save the storage space of the second memory unit.

In one implementation, the transmitting-end electronic device 10 for example may be a laptop which can use the first processing unit thereto control operations including, file transfer, file combination, establishing and deleting the temporary folder and the recording file 17 associated with the first memory unit of the transmitting-end electronic device 10 and the second memory unit of the receiving-end electronic device 20 when transferring data to the receiving-end electronic device 20 not having the second processing unit through the aforementioned transmission interface 31a-31n.

It should be noted that the internal structure of the transmitting-end electronic device 10 and the receiving-end electronic device 20 may vary according to the type and actual structure of the transmitting-end electronic device 10 and the receiving-end electronic device 20. In other words, FIG. 2 is merely adopted for illustrating the data transfer method between the transmitting-end electronic device 10 and the receiving-end electronic device 20 and the present disclosure is not limited thereto.

### Second Exemplary Embodiment

From the aforementioned exemplary embodiment, the present disclosure may generalize a data transfer method which can be adapted for a data transfer system having a transmitting-end electronic device and a receiving-end electronic device 20 illustrated in the aforementioned embodiment. The data transfer method may be used to regulate the data transferring processing between the transmitting-end electronic device and the receiving-end electronic device. The transmitting-end electronic device may be a cellular phone, a laptop, a computer, or a tablet, and the instant embodiment is not limited thereto. The receiving-end electronic device may be a cellular phone, a laptop, a computer, a tablet, a flash drive, or a portable hard drive, and the instant embodiment is not limited thereto

Please refer to FIG. 3-1 and FIG. 3-2 in conjunction to FIG. 1, in which FIG. 3-1 and FIG. 3-2 are flowchart diagrams illustrating a data transfer method adapted for a transmitting-end electronic device provided in accordance to the second exemplary embodiment of the present disclosure.

In Step S101, the transmitting-end electronic device 10 receives a data transfer instruction. The data transfer instruction can be generated by the user of the transmitting-end electronic device 10. For instance, the user may create the data transfer instruction through the input interface e.g., keypad or touch screen (not shown) of the transmitting-end electronic device 10. The data transfer instruction may comprise of at least one of the associated file location of the file to bet transferred and the desired data transmission interface. Subsequently, the transmitting-end electronic device 10 can in Step S103 determines the size of the split-files based on the size of a file to be transferred and computes the corresponding quantity of the split-file. The file to be transferred may be an image file, a text file, a video file, an audio file or a combination thereof, the instant embodiment is not limited to the example provided herein.

In Step 105, the transmitting-end electronic device 10 may establish a recording file in a temporary folder in corresponding to the split-files. The recording file can be used to record the sequence of the split-files and the corresponding transmission progress. In Step S107, the transmitting-end electronic device 10 splits the file to be transferred to generate multiple split-files having identical or different size according computed the size of split-file and the quantity of the split-files, wherein the split-files are stored in the temporary folder of the transmitting-end electronic device 10. In Step S109, the transmitting-end electronic device 10 sequentially transfers the split split-files to the receiving-end electronic device 20 through the predefined primary data transmission interface according to the recording file. Meanwhile, the transmitting-end electronic device 10 continues with the file-splitting process until finishing splitting the file to be transferred into the split-files. The transmitting-end electronic device 10 further records the transmission progress in corresponding to the split-files in the recording file as illustrated in Step S111.

As shown in Step 113, during the process of transferring the split-files, the transmitting-end electronic device 10 detects and determines whether or not the transmission of the primary data transmission interface has been interrupted. For instance, the transmitting-end electronic device 10 may activate a transmission interface monitor program to detect whether or not the data transfer rate of the primary data transmission interface is lower than a predetermined value, wherein the predetermined value may be configured according to the standard data transfer rate of the primary data transmission interface. When detected that the transmission of the primary data transmission interface has not been interrupted, executes Step S123, otherwise executes Step S115.

In Step S115, the transmitting-end electronic device 10 determines whether or not the data (e.g., the split-files) can be transferred through a secondary data transmission interface while continue with the file-splitting process until finished splitting the file to be transferred into split-files. The transmitting-end electronic device 10 can detect all the data transmission interface between the transmitting-end electronic device 10 and the receiving-end electronic device 20 so as to select a data transmission interface (e.g., a data transmission interface providing the fastest data transfer rate) to be the secondary data transmission interface.

When the transmitting-end electronic device 10 determines that data (e.g., the split-files) can be transferred through the secondary data transmission interface, executes Step S119. On the other hand, when the transmitting-end electronic device 10 determines that at the instant the transmitting-end electronic device 10 is unable to transfer data (e.g., the split-files) through any data transmission interfaces, such as the respective file size is too large or the file format can only be transferred through the primary data transmission interface or when the transmitting-end electronic device 10 cannot establish communication link with any other data transmission interface, executes Step S117.

In Step S117, the transmitting-end electronic device 10 await for the communication link with the primary data transmission interface or the secondary data transmission interface has been reestablished and continue transferring the split-files through the respective linked data transmission interface.

In Step S119, the transmitting-end electronic device 10 switches from the primary data transmission interface to the secondary data transmission interface. Such that the transmitting-end electronic device 10 can continue transferring the split-files to the receiving-end electronic device 20 through the secondary data transmission interface according to the recording file as illustrated in Step S121.

Then in Step S123, the transmitting-end electronic device 10 determines whether or not the process of transferring the split-files has been completed. The transmitting-end electronic device 10 may send a verification message to the receiving-end electronic device 20 to request a response regarding whether or not the receiving-end electronic device 20 has finished the process of receiving all the split-files in corresponding to the file to be transferred. The transmitting-end electronic device 10 determines whether or not the process of transferring the split-files has been completed based on the response from the receiving-end electronic device 20.

When the transmitting-end electronic device 10 determines that the process of transferring the spilt-file has not been completed, executes Step S125. On the other hand, when the transmitting-end electronic device 10 determines that the process of transferring the spilt-files has been completed, e.g., receiving a transmission completion message from the receiving-end electronic device 20 verifies that the process of transferring the split-files has been completed, executes Step S127.

In Step 125, the transmitting-end electronic device 10 correspondingly updates the transmission progress of the split-files in the recording file. In Step S127, the transmitting-end electronic device 10 deletes the temporary folder, or equivalently deletes the split-files and the recording file.

Incidentally, during the process of transferring the split-files using the secondary data transmission interface, if the communication link with the primary data transmission interface has recovered, and the data transfer rate provided by the primary data transmission interface is faster than the data transfer rate provided by the secondary data transmission interface, the transmitting-end electronic device 10 may switch to the primary data transmission interface and continue transferring the split-files so as to accelerate the data transferring speed.

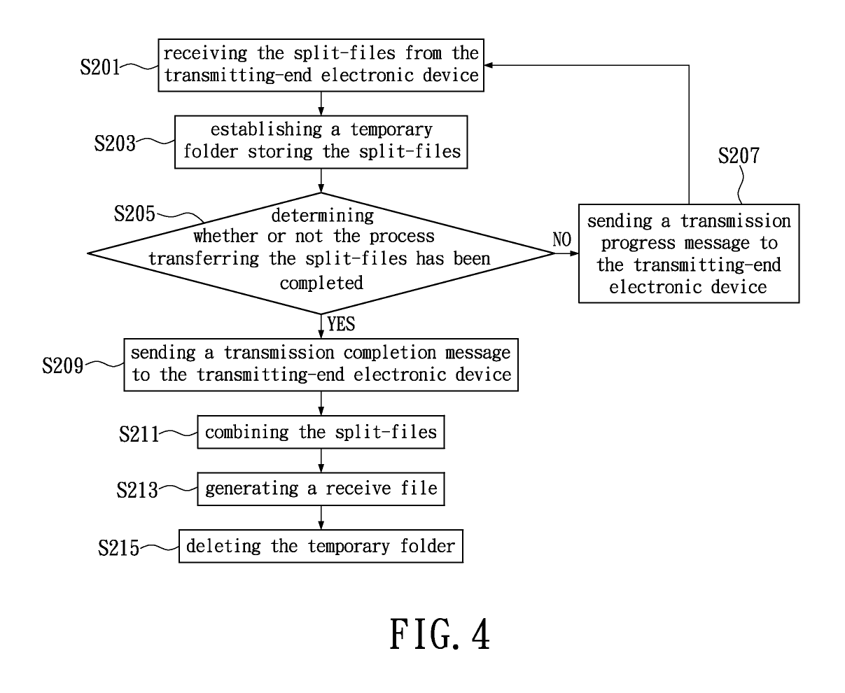

Next, please refer to FIG. 4 in conjunction with FIG. 1. FIG. 4 a flowchart diagram of a data transfer method adapted for a receiving-end electronic device provided in accordance to the second exemplary embodiment of the present disclosure.

In Step S201, when the primary data transmission interface operates normally, the receiving-end electronic device 20 may receive the split-files from the transmitting-end electronic device 10 through the primary data transmission interface. In Step S203, the receiving-end electronic device 20 establishes a temporary folder therein for storing the received split-files. The split-files correspond to a file to be transferred stored in the transmitting-end electronic device 10. In Step S205, the receiving-end electronic device 20 determines whether or not the process of transferring the split-files has been completed. If the receiving-end electronic device 20 determines that the split-files has been completed executes Step S209, otherwise executes Step S207

In Step S207, the receiving-end electronic device 20 sends a transmission progress message to the transmitting-end electronic device 10 to have the transmitting-end electronic device 10 correspondingly updating the recording file stored therein according to the transmission progress message. Then returns to Step S201, continue receiving the split-files transferred by the transmission progress message.

In Step S209, the receiving-end electronic device 20 sends a transmission completion message to the transmitting-end electronic device 10 to have the transmitting-end electronic device 10 acknowledged that the process of transferring the split-files has been completed. Subsequently, in Step S211, the receiving-end electronic device 20 combine the received split-files stored in the temporary folder of the receiving-end electronic device 20 using file recombination technique. In Step S213, the receiving-end electronic device 20 generates a receive file. In Step S215, the receiving-end electronic device 20 deletes the temporary folder containing the split-files. The receive file is the same as the file to be transferred.

Additionally, when the transmission of the primary data transmission interface has been interrupted during the process of transferring the split-files prior to the completion of transferring the split-files, the receiving-end electronic device 20 may provide a plurality of data transmission interfaces for the transmitting-end electronic device 10 to select from. So that the transmitting-end electronic device 10 may select a secondary data transmission interfaces from the provided selections of the data transmission interfaces to resumes the process of transferring the remaining split-files. At the same time, the receiving-end electronic device 20 may retain the received split-files in the temporary folder and wait for the transmitting-end electronic device 10 to resume the process of transferring the remaining split-files.

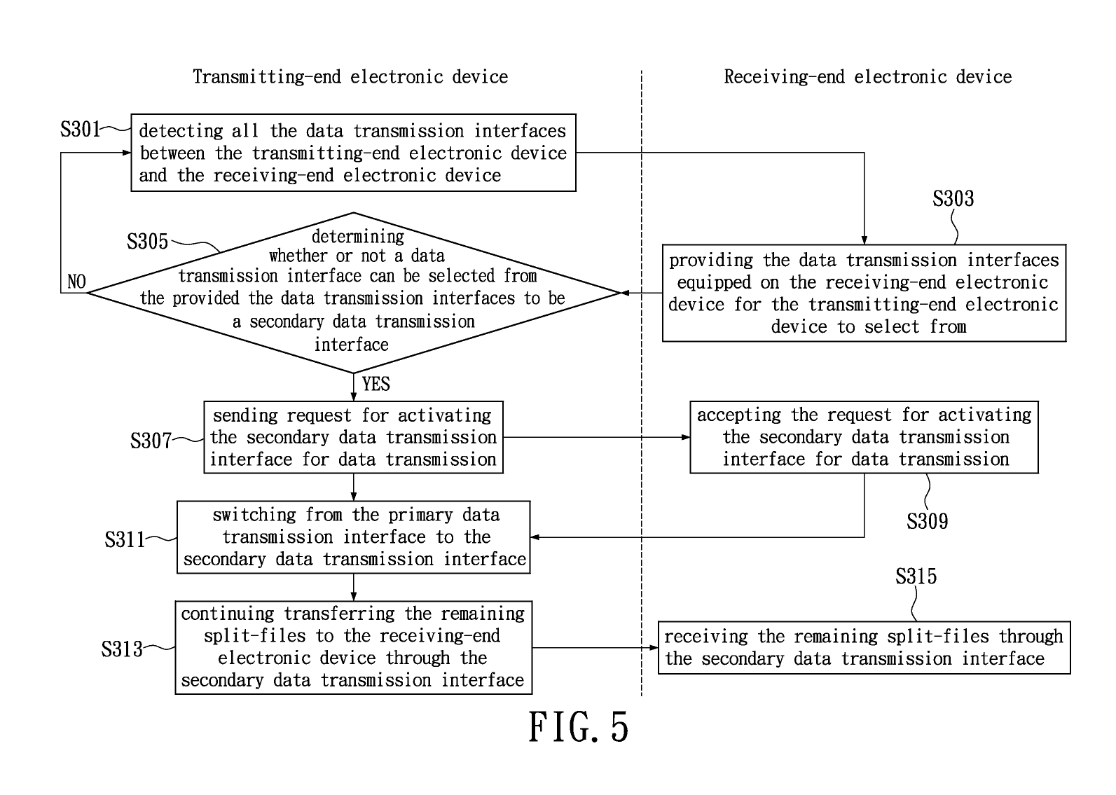

Based on the above explanation, the present disclosure may further generalize a data transfer method when the transmission of primary data transmission interface between the transmitting-end electronic device and the receiving-end electronic device has been interrupted. Please refer to FIG. 5 in conjunction with FIG. 1, wherein FIG. 5 is a flowchart diagram of a data transfer method for handling data transfer interruption provided in accordance to the second exemplary embodiment of the present disclosure.

In Step S301, when the transmitting-end electronic device 10 detects that the transmission of the primary data transmission interface has been interrupted, the transmitting-end electronic device 10 immediately detecting all other alternative data transmission interface between the transmitting-end electronic device 10 and the receiving-end electronic device 20. In Step S303, the receiving-end electronic device 20 provides a plurality data transmission interfaces thereof for the transmitting-end electronic device 10 to select. In Step S305, the transmitting-end electronic device 10 determines whether or not any of the provided data transmission interface can be selected as the secondary data transmission interface. When the transmitting-end electronic device 10 determines a data transmission interface can be selected to be the secondary data transmission interface, the transmitting-end electronic device 10 executes Step S307; otherwise, the transmitting-end electronic device 10 executes Step S305.

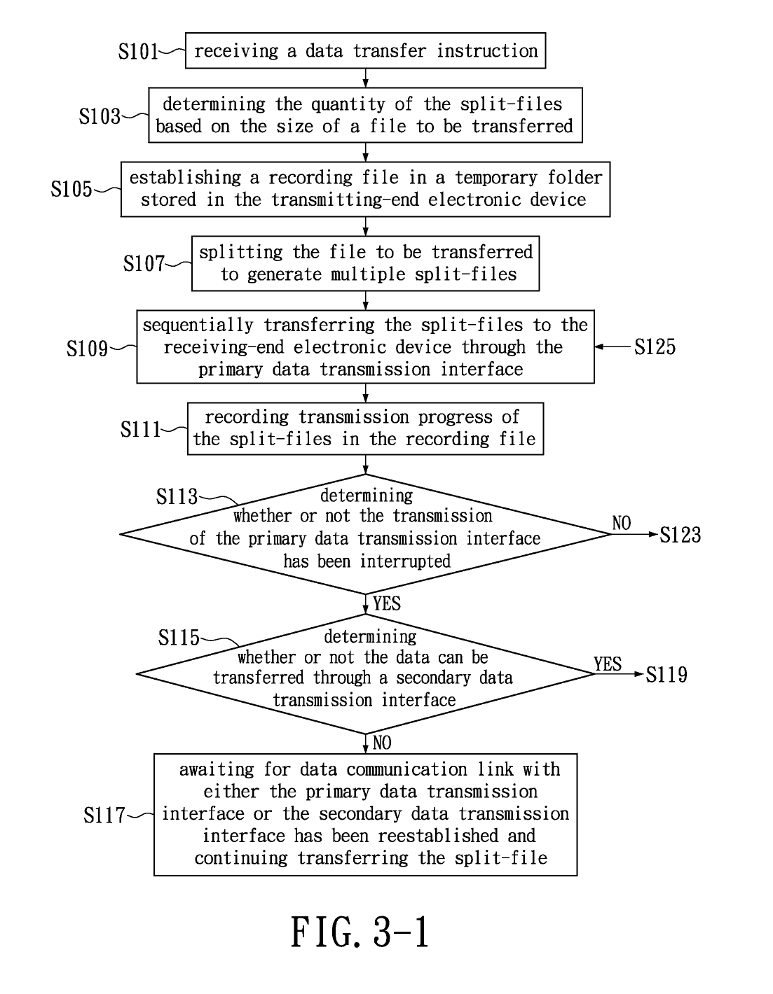

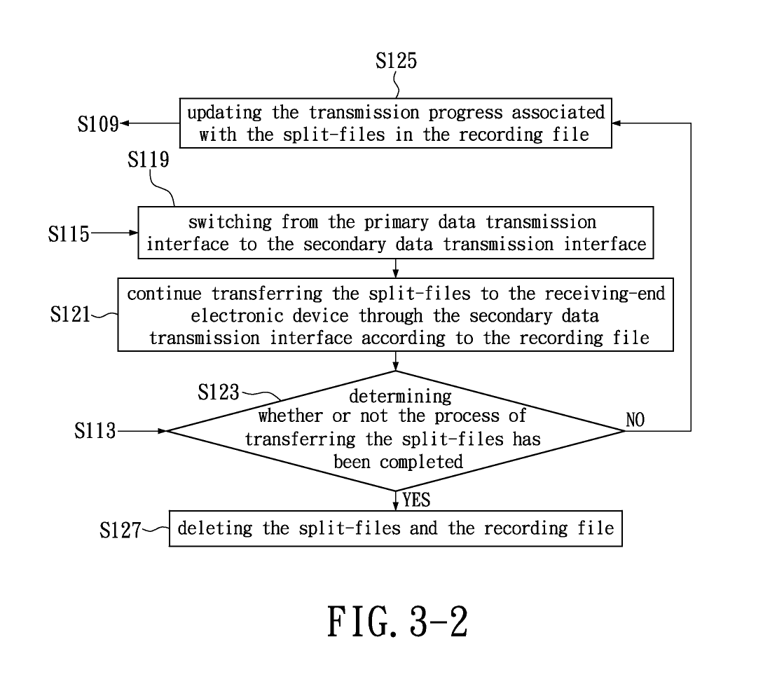

In Step S307, the transmitting-end electronic device 10 select a specific data transmission interface (e.g., the data transmission interface providing the fastest data transfer rate) to be the secondary data transmission interface and sends a request to the receiving-end electronic device 20 to activate the secondary data transmission interface for data transmission. The receiving-end electronic device 20 accepts the request for activating the secondary data transmission interface for data transmission and establishes the communication link of the secondary data transmission interface, accordingly. It is worth to note that during the process of data transmission interface interruption, detecting an alternate data transmission interface and switching between the primary data transmission interface and the secondary data transmission interface, the transmitting-end electronic device 10 continue file-splitting process of the file to be transferred unit finishing splitting the file to be transferred into split-files. In Step S311, the transmitting-end electronic device 10 switches from the primary data transmission interface and the secondary data transmission interface. Next, in Step S313, the transmitting-end electronic device 10 continues transferring the remaining split-files stored in the temporary folder of the transmitting-end electronic device 10 to the receiving-end electronic device 20 through the secondary data transmission interface according to the sequence in the recording file. The receiving-end electronic device 20 receives the split-files through the secondary data transmission interface and stores the split-files in the temporary folder of the receiving-end electronic device 20. Based on the above expiations and the illustration of FIG. 3, those skilled in the art should be able to infer the details for the method of generating and transferring the split-files, updating the recording file, verification of the transmission progress, further descriptions are therefore omitted.

It is worth to note that the data transferred method depicted in FIG. 3 and FIG. 5 to be implemented by the transmitting-end electronic device 10 may be executed by the first processing unit of the transmitting-end electronic device 10. Similarly, the data transferred method depicted in FIG. 4 and FIG. 5 to be implemented by the receiving-end electronic device 20 may be executed by the second processing unit of the receiving-end electronic device 20. The first processing unit and the second processing unit may for example be the processing chips such as central processing unit, microcontroller or embedded controller and are respectively placed in the transmitting-end electronic device 10 and the receiving-end electronic device 20, however the instant embodiment is not limited thereto.

The temporary folder of the transmitting-end electronic device 10 may be stored in the first memory unit of the transmitting-end electronic device 10. The temporary folder of the receiving-end electronic device 20 may be stored in the second memory unit of the receiving-end electronic device 20. In addition, the first memory unit and the second memory unit in the instant embodiment may be implemented by a volatile memory chip or a non-volatile memory chip such as a flash memory chip, a read-only memory chip or a random access memory chip, however the instant embodiment is not limited thereto.

The primary data transmission interface and the secondary data transmission interface may each be a Universal Serial Bus (USB), a IEEE 1394, an external Serial Advanced Technology Attachment (eSATA), a Thunderbolt interface, a PS/2 interface, a COM PORT interface, a Bluetooth interface, a WiFi, or a Registered Jack 45 (RJ45) interface.

In one implementation, the data transmission interfaces (e.g., the primary data transmission interface and the secondary data transmission interface) between the transmitting-end electronic device 10 and the receiving-end electronic device 20 do not include a local area network or an internet. In another implementation, the data transmission interfaces (e.g., the primary data transmission interface and the secondary data transmission interface) between the transmitting-end electronic device 10 and the receiving-end electronic device 20 further include a local area network or an internet. In other words, the type, actual structure, and/or implementation method associated with the primary data transmission interface and the secondary data transmission interface are configured according to the type and actual structural of the transmitting-end electronic device 10 and the receiving-end electronic device 20, thus the present disclosure is not limited thereto.

It should be noted that FIG. 3 and FIG. 4 are merely used to illustrate the generalized data transfer method provided by the present disclosure adopted for the transmitting-end electronic device 10 and the receiving-end electronic device 20 and the present disclosure is not limited thereto. Similarly, FIG. 5 is merely used for description the interaction between the transmitting-end electronic device 10 and the receiving-end electronic device 20 when the transmission of the data transmission interface therebetween has been interrupted and the present disclosure is not limited thereto.

In summary, an exemplary embodiment of the present disclosure provides a data transfer method which can actively detect and select a data transmission interface as replacement to continue transfer data when data transferring process of the instantly used data transmission interface between the transmitting-end electronic device and the receiving-end electronic device has been interrupted. Accordingly, the data transmission time between the transmitting-end electronic device and the receiving-end electronic device can be effectively reduced. Moreover, as data retransmission may be avoided consequently power used in data transmission between the transmitting-end electronic device and the receiving-end electronic can be conserved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A data transfer method, adapted for a transmitting-end electronic device, for regulating the data transferring process between the transmitting-end electronic device and a receiving-end electronic device, the method comprising:
computing the quantity of the split-files according to the size of a file to be transferred stored in the transmitting-end electronic device, when the transmitting-end electronic device receives a data transfer instruction;
establishing a recording file in the transmitting-end electronic device in corresponding to the file to be transferred;
splitting the file to be transferred to generate a plurality of split-files;
sequentially transferring the split-files to the receiving-end electronic device through a primary data transmission interface and recording the corresponding transmission progress in the recording file;
detecting whether or not the transmitting-end electronic device can transfer data through a secondary data transmission interface when the transmission of the primary data transmission interface has been interrupted during the process of transferring the split-files; and
resuming transferring the rest of the split-files to the receiving-end electronic device through the secondary data transmission interface according to the recording file when determined that the transmitting-end electronic device can transfer data through the secondary data transmission interface.

2. The data transfer method according to claim 1, wherein the step of establishing the recording file in the transmitting-end electronic device in corresponding to the file to be transferred further comprises:
establishing a temporary folder in the transmitting-end electronic device for storing the split-files and the recording file; and
deleting the temporary folder after finishing transferring the split-files.

3. The data transfer method according to claim 2, wherein the step of deleting the temporary folder further comprises:
deleting the split-files and the recording file stored in the temporary folder.

4. The data transfer method according to claim 1, wherein the step of establishing the recording file in the transmitting-end electronic device in corresponding to the file to be transferred further comprises:
deleting the split-files and the recording file stored in the transmitting-end electronic device after completing the process of transferring the split-files.

5. The data transfer method according to claim 1, wherein the step of recording the corresponding transmission progress in the recording file further comprises:
updating the recording file after each split-file has been transferred to correspondingly record the transmission progress associated with the split-files.

6. The data transfer method according to claim 1, wherein the step of sequentially transferring the split-files to the receiving-end electronic device through the primary data transmission interface comprises activating a transmission interface monitor program to monitor whether or not the transmission of the primary data transmission interface has been interrupted.

7. The data transfer method according to claim 1, wherein the step of detecting whether or not the transmitting-end electronic device can transfer data through the secondary data transmission interface further comprises:
detecting all the data transmission interfaces between the transmitting-end electronic device and the receiving-end electronic device and selecting one of the data transmission interfaces to be the secondary data transmission interface, accordingly.

8. The data transfer method according to claim 7, wherein the secondary data transmission interface is the data transmission interface providing fastest data transfer rate out of all the data transmission interfaces.

9. The data transfer method according to claim 1, wherein the step of continuing transferring the split-files to the receiving-end electronic device through the secondary data transmission interface comprises:
switching from the primary data transmission interface to the secondary data transmission interface to continue transferring the split-files to the receiving-end electronic device through the secondary data transmission interface.

10. The data transfer method according to claim 1, further comprising:
when determined that the transmitting-end electronic device is unable to transfer data through any data transmission interface, await for the communication link with the primary data transmission interface or the secondary data transmission interface has been reestablished and resuming transferring the rest of the split-files.

11. The data transfer method according to claim 1, wherein the step of detecting whether or not the transmitting-end electronic device can transfer data through the secondary data transmission interface further comprises:
sending request to the receiving-end electronic device to activate the secondary data transmission interface.

12. The data transfer method according to claim 1, further comprising:
sending a verification request to the receiving-end electronic device to have the receiving-end electronic device respond to whether or not the receiving-end electronic device has finished receiving all the split-files; and
receiving a transmission completion message from the receiving-end electronic device to verify that the process of transferring the split-files has been completed.

13. The data transfer method according to claim 1, wherein the primary data transmission interface is a Universal Serial Bus (USB) or an external Serial Advanced Technology Attachment (eSATA), and the secondary data transmission interface is a WiFi or a Registered Jack 45 (RJ45) interface.

14. The data transfer method according to claim 1, wherein the secondary data transmission interface is a Universal Serial Bus (USB), or an external Serial Advanced Technology Attachment (eSATA), and the primary data transmission interface is a WiFi or a Registered Jack 45 (RJ45) interface.

15. The data transfer method according to claim 1, wherein the transmitting-end electronic device is a cellular phone, a laptop, a computer, or a tablet.

16. The data transfer method according to claim 1, wherein the receiving-end electronic device is a cellular phone, a laptop, a computer, a tablet, a flash drive, or a portable hard drive.

17. The data transfer method according to claim 1, wherein the step of sequentially transferring the split-files to the receiving-end electronic device through the primary data transmission interface further comprises:
continuing splitting the file to be transferred during the process of transferring the split-files until finishing splitting the file to be transferred.

18. The data transfer method according to claim 1, wherein the step of sequentially transferring the split-files to the receiving-end electronic device through the primary data transmission interface further comprises:
continuing splitting the file to be transferred even when the transmission of the primary data transmission interface has been interrupted until finishing splitting the file to be transferred.

19. A data transfer method, adapted for a receiving-end electronic device, for regulating the data transferring process between the receiving-end electronic device and a transmitting-end electronic device, the method comprising:
receiving a plurality of split-files from the transmitting-end electronic device through a primary data transmission interface, wherein the split-files correspond to a file to be transferred;
providing multiple data transmission interfaces equipped on the receiving-end electronic device for the transmitting-end electronic device to select a secondary data transmission interface from the data transmission interfaces when the transmission of the primary data transmission interface has been interrupted to resume receiving the rest of the split-files; and
determining whether or not the process of transferring the split-files has been completed, combining the split-files to generate a receive file when the process of the transferring the split-files has been completed; if the process of transferring the split-files has not been completed, send a transmission progress message to the transmitting-end electronic device to update a recording file based on the transmission progress message.

20. The data transfer method according to claim 19, wherein the step of receiving a plurality of the split-files from the transmitting-end electronic device, comprises:
establishing a temporary folder for storing the received split-files;
wherein the temporary folder is retained prior to the completion of transferring the split-files, and the temporary folder is deleted after all the split-files been received and combined into the receive file.

21. The data transfer method according to claim 20, wherein the step of establishing the temporary folder further comprises:
retaining the split-files when the transmission of the primary data transmission interface has been interrupted prior to the completion of transferring the split-files and wait for the transmitting-end electronic device to resume the process of transferring the split-file.

22. (canceled)

23. The data transfer method according to claim 19, wherein the file to be transferred is the same as the receive file.

24. The data transfer method according to claim 19, wherein the primary data transmission interface is a Universal Serial Bus (USB) or an external Serial Advanced Technology Attachment (eSATA), and the secondary data transmission interface is a WiFi or a Registered Jack 45 (RJ45) interface.

25. The data transfer method according to claim 19, wherein the secondary data transmission interface is a Universal Serial Bus (USB) or an external Serial Advanced Technology Attachment (eSATA), and the primary data transmission interface is a WiFi or a Registered Jack 45 (RJ45) interface.

26. The data transfer method according to claim 19, wherein the transmitting-end electronic device is a cellular phone, a laptop, a computer, or a tablet.

27. The data transfer method according to claim 19, wherein the receiving-end electronic device is a cellular phone, a laptop, a computer, a tablet, a flash drive, or a portable hard drive.

28. A data transfer method, adapted for a transmitting-end electronic device and a receiving-end electronic device, for regulating the data transferring process between the transmitting-end electronic device and the receiving-end electronic device, the method comprising:
processing the following steps on the transmitting-end electronic device:
computing the quantity of the split-files according to the size of a file to be transferred stored in the transmitting-end electronic device, when the transmitting-end electronic device receives a data transfer instruction;
establishing a recording file in the transmitting-end electronic device in corresponding to the file to be transferred;
splitting the file to be transferred to generate a plurality of split-files;
sequentially transferring the split-files to the receiving-end electronic device through a primary data transmission interface and recording the corresponding transmission progress in the recording file;
detecting whether or not the transmitting-end electronic device can transfer data through a secondary data transmission interface when the transmission of the primary data transmission interface has been interrupted during the process of transferring split-files; and
resuming transferring the rest of the split-files to the receiving-end electronic device through the secondary data transmission interface according to the recording file when determined that the transmitting-end electronic device can transfer data through the secondary data transmission interface; and
processing the following steps on the receiving-end electronic device:
receiving a plurality of the split-files from the transmitting-end electronic device through a primary data transmission interface;
providing multiple data transmission interfaces equipped on the receiving-end electronic device for the transmitting-end electronic device to select a secondary data transmission interface from the data transmission interfaces when the transmission of the primary data transmission interface has been interrupted to resume receiving the rest of the split-files; and
determining whether or not the process of transferring the split-files has been completed, combining the split-files to generate a receive file when the process of transferring the split-files has been completed; if the process of transferring the split-files has not been completed, send a transmission progress message to the transmitting-end electronic device to update a recording file based on the transmission progress message.

29. The data transfer method according to claim 28, wherein the step of establishing the recording file in the transmitting-end electronic device in corresponding to the file to be transferred further comprises:
establishing a temporary folder in the transmitting-end electronic device for storing the split-files and the recording file; and
deleting the temporary folder after completing the process of transferring the split-files.

30. The data transfer method according to claim 28, wherein the step of deleting the temporary folder further comprises:
deleting the split-files and the recording file stored in the temporary folder.

31. The data transfer method according to claim 28, wherein the step of establishing the recording file in the transmitting-end electronic device in corresponding to the file to be transferred further comprises:
deleting the split-files and the recording file stored in the transmitting-end electronic device after completing the process of transferring the split-files.

32. The data transfer method according to claim 28, wherein the step of recording the corresponding transmission progress in the recording file further comprises:
updating the recording file after each split-file has been transferred to correspondingly record the transmission progress associated with the split-files.

33. The data transfer method according to claim 28, wherein sequentially transferring the split-files to the receiving-end electronic device through the primary data transmission interface comprises activating a transmission interface monitor program to monitor whether or not the transmission of the primary data transmission interface has been interrupted.

34. The data transfer method according to claim 28, wherein the step of detecting whether or not the transmitting-end electronic device can transfer data through the secondary data transmission interface further comprises:
detecting all the data transmission interfaces between the transmitting-end electronic device and the receiving-end electronic device and selecting one of the data transmission interfaces to be the secondary data transmission interface, accordingly.

35. The data transfer method according to claim 34, wherein the secondary data transmission interface is the data transmission interface providing fastest data transfer rate out of all the data transmission interfaces.

36. The data transfer method according to claim 28, wherein the step of continuing transferring the split-files to the receiving-end electronic device through the secondary data transmission interface comprises:
switching from the primary data transmission interface to the secondary data transmission interface to continue transferring the split-files to the receiving-end electronic device through the secondary data transmission interface.

37. The data transfer method according to claim 28, further comprising:
when determined that the transmitting-end electronic device is unable to transfer data through any data transmission interface, await for the communication link with the primary data transmission interface or the secondary data transmission interface has been reestablished and resuming transferring the rest of the split-file.

38. The data transfer method according to claim 28, wherein the step of detecting whether or not the transmitting-end electronic device can transfer data through the secondary data transmission interface further comprises:
sending request to the receiving-end electronic device to activate the secondary data transmission interface.

39. The data transfer method according to claim 28, further comprising:
sending a verification request to the receiving-end electronic device to have the receiving-end electronic device respond to whether or not the receiving-end electronic device has finished receiving all the split-files; and
receiving a transmission completion message from the receiving-end electronic device to verify that the process of transferring the split-files has been completed.

40. The data transfer method according to claim 28, wherein the primary data transmission interface is a Universal Serial Bus (USB) or an external Serial Advanced Technology Attachment (eSATA), and the secondary data transmission interface is a WiFi or a Registered Jack 45 (RJ45) interface.

41. The data transfer method according to claim 28, wherein the secondary data transmission interface is a Universal Serial Bus (USB) or an external Serial Advanced Technology Attachment (eSATA), and the primary data transmission interface is a WiFi or a Registered Jack 45 (RJ45) interface.

42. The data transfer method according to claim 28, wherein the transmitting-end electronic device is a cellular phone, a laptop, a computer, or a tablet.

43. The data transfer method according to claim 28, wherein the receiving-end electronic device is a cellular phone, a laptop, a computer, a tablet, a flash drive, or a portable hard drive.

44. The data transfer method according to claim 28, wherein the step of receiving a plurality of the split-files from the transmitting-end electronic device, comprises:
establishing a temporary folder for storing the received split-files;
wherein the temporary folder is retained prior to the completion of transferring the split-file, and the temporary folder is deleted after all the split-files been received and combined into the receive file.

45. The data transfer method according to claim 44, wherein the step of establishing the temporary folder further comprises:
retaining the split-files when the transmission of the primary data transmission interface has been interrupted prior to the completion of transferring the split-files and wait for the transmitting-end electronic device to resume the process of transferring split-files.

46. (canceled)

47. The data transfer method according to claim 28, wherein the file to be transferred is the same as the receive file.

48. The data transfer method according to claim 28, wherein the data transmission interfaces between the transmitting-end electronic device and the receiving-end electronic device do not comprise of a local area network or an internet.

49. The data transfer method according to claim 28, wherein the data transmission interfaces between the transmitting-end electronic device and the receiving-end electronic device further comprise of a local area network or an internet.

50. The data transfer method according to claim 28, wherein the step of detecting whether or not the transmitting-end electronic device can transfer data through the secondary data transmission interface when the transmission of the primary data transmission interface has been interrupted further comprises:
the transmitting-end electronic device determining that the primary data transmission interface has been interrupted when the data transfer rate is lower than a predetermined value.

51. The data transfer method according to claim 50, further comprising:
the transmitting-end electronic device switching to the primary data transmission interface for data transmission when the data transfer rate of the primary data transmission interface is larger than the data transfer rate of the secondary data transmission interface.

52. The data transfer method according to claim 28, wherein the step of sequentially transferring the split-files to the receiving-end electronic device through the primary data transmission interface further comprises:
continuing splitting the file to be transferred during the process of transferring the split-files until finishing splitting the file to be transferred.

53. The data transfer method according to claim 28, wherein the step of sequentially transferring the split-files to the receiving-end electronic device through the primary data transmission interface further comprises:
continuing splitting the file to be transferred even when the transmission of the primary data transmission interface has been interrupted until finishing splitting the file to be transferred.

54. The data transfer method according to claim 1, wherein the primary data transmission interface is a Universal Serial Bus (USB), or a IEEE 1394, or an external Serial Advanced Technology Attachment (eSATA) while the secondary data transmission interface is a USB, or an eSATA.

55. The data transfer method according to claim 19, wherein the primary data transmission interface is a Universal Serial Bus (USB), or a IEEE 1394, or an external Serial Advanced Technology Attachment (eSATA), and the secondary data transmission interface is a USB, or an eSATA.

56. The data transfer method according to claim 28, wherein the primary data transmission interface is a Universal Serial Bus (USB), or a IEEE 1394, or an external Serial Advanced Technology Attachment (eSATA), and the secondary data transmission interface is a USB, or an eSATA.
